(19) United States
(12) Patent Application Publication
(10) Pub. No.: US 2009/0169707 A1
(43) Pub. Date: Jul. 2, 2009

(54) PROCESS OF PRODUCING WHOLE WHEAT FLOUR

(75) Inventors: Yasuo ITO, Tokyo (JP); Koji MURAKAMI, Tokyo (JP); Satoshi SEKIGUCHI, Chiba (JP); Takeshi IWAKURA, Tokyo (JP); Katsuyuki IKEDA, Saitama (JP)

Correspondence Address: Young & Thompson, 745 S. 23rd Street, Second Floor, Arlington, VA, 22202, US

(73) Assignees: NISSHIN FLOUR MILLING INC., Tokyo (JP); NISSHIN SEIFUN GROUP INC., Tokyo (JP)

(21) Appl. No.: 11/966,105

(22) Filed: Dec. 28, 2007

(51) Int. Cl. A21D 6/00; A23L 1/10

(52) U.S. Cl. 426/622; 426/518; 426/455

(57) ABSTRACT

A process of producing whole wheat flour including the steps of (1) coarsely grinding wheat kernels, (2) separating the resulting ground product into a fine fraction with an average particle size less than a size ranging from 150 to 200 μm and a coarse fraction with an average particle size more than that of the fine fraction and at or above a size ranging from 150 to 200 μm, (3) pulverizing the coarse fraction by impact grinding, (4) fractionating the resulting ground product obtained in step (3) to collect a fine fraction with an average particle size less than a size ranging from 150 to 200 μm, and (5) combining the fine fraction from step (2) and the fine fraction obtained in step (4). Preferably, the coarse fraction obtained in step (2) is subjected to a heat-moisture treatment, and the heat-moisturized fraction is pulverized by impact grinding in step (3).

### BACKGROUND OF THE INVENTION

1. Field of the Invention

This invention relates to a process for efficiently producing whole wheat flour that is easy to process and provides processed foods with good appearance, flavor, and texture.

2. Description of the Related Art

The recent increasing awareness of health issues has boosted the demand for whole wheat meal or flour containing bran and germ rich in nutrients such as fiber, vitamins and minerals and providing a flavor unique to wheat bran. Whole wheat meal has historically been prepared by milling wheat kernels (raw material wheat) into meal, which may be further ground into flour. Because wheat bran is hard to mill, the thus prepared wheat meal still contains a considerable amount of large fragments of bran, which has not only provided a rough texture to the mouth, a branny smell, and a bitter taste unique to bran but caused poor processability of the meal. When further ground, the flour has somewhat reduced roughness of texture but still contains relatively large fragments of bran because of difficulty of pulverizing wheat bran. If the further ground wheat flour is furthermore ground into finer particles, the endosperm fraction will be ground excessively only to provide wheat flour in which starch and gluten are seriously damaged, and processed foods prepared therefrom will have poor qualities.

In an attempt to solve the problem, Canadian Patent 2,141,974 proposes a method characterized by milling wheat kernels with an air attrition mill and recycling larger particles of the milled product than about 150 μm into the air attrition mill to form an ultra-fine whole wheat flour. However, the method achieves a poor grinding efficiency because the grinding means is based on collision of particles caused by an air stream. Moreover, the re-grinding of the particles larger than about 150 μm in the air attrition mill results in accelerated damage to the starch and gluten.

WO 2005/058044 discloses a process for producing an ultrafine-milled whole wheat flour comprising the steps of providing cleaned and tempered wheat kernels, milling the wheat kernels in a mill twice or more times, separating the milled product into a fine fraction (wheat flour) and a coarse fraction of bran and germ, pulverizing the coarse fraction to fine particles, and mixing the resulting ground product with the fine fraction (see FIG. 1). Whole wheat flour produced by this process has already been sold in the market. The process, however, does not bring about so much improvement on grinding efficiency. Moreover, the pulverization causes damage to the starch and gluten. When the whole wheat flour produced by the process is used to make bread, while it absorbs an increased amount of water, being helped by the low water content of dough prepared therefrom, the dough slackens off considerably to exhibit poor breadmaking properties, only providing bread with poor qualities. In other words, the whole wheat flour has poor processability, and processed products prepared therefrom cannot be said to have satisfactory qualities. WO 2005/058044 states that the microbial load of the coarse fraction comprising bran and germ is reduced by the heat generated in the step of pulverization but is silent on a heat-moisture treatment.

JP 62-16621B discloses a method comprising heating wheat grains, e.g., with steam to suppress enzyme activities in the grains, separately grinding an endosperm fraction and a non-endosperm fraction containing bran, and mixing the millings from the two fractions. JP 2001-204411A teaches a process comprising milling wheat in a usual manner into a bran fraction, a germ fraction, and a wheat flour fraction, roasting the bran fraction, and finely grinding the roasted bran fraction. However, the step of directly heating wheat kernels as adopted in JP 62-16621B encounters difficulty in controlling the heating and tends to involve excessive heating, which can result in destroying the structure of gluten and starch of wheat. The step of roasting bran as adopted in JP 2001-204411A causes damage to the structure of gluten and starch of bran. It is considered, therefore, that the whole wheat flour produced by these processes cannot get rid of the problem of poor processability.

### SUMMARY OF THE INVENTION

An object of the present invention is to provide a process of producing whole wheat flour that has good processability and provides processed foods with good appearance, flavor, and texture.

As a result of extensive investigations, the present inventors have found that whole wheat flour produced by a specific process exhibits good processability and that processed products prepared therefrom have satisfactory appearance, flavor and texture. The process includes milling wheat kernels, classifying the millings into a fine fraction of particles under a specific size and a coarse fraction of particles at or above the specific size, pulverizing the coarse fraction in an impact pulverizer preferably after subjecting the coarse fraction to a heat-moisture treatment, classifying the resulting fine particles, and combining the resulting fine fraction with the previously separated fine fraction. The invention has been completed based on these findings.

The object of the invention is accomplished by the provision of a process of producing whole wheat flour comprising the steps of (1) coarsely grinding wheat kernels, (2) separating the resulting ground product into a fine fraction with an average particle size less than a size ranging from 150 to 200 μm and a coarse fraction with an average particle size more than that of the fine fraction and at or above a size ranging from 150 to 200 μm, (3) pulverizing the coarse fraction by impact grinding, (4) fractionating the resulting ground product obtained in step (3) to collect a fine fraction with an average particle size less than a size ranging from 150 to 200 μm, and (5) combining the fine fraction with an average particle size less than a size ranging from 150 to 200 μm obtained in step (2) and the fine fraction with an average particle size less than a size ranging from 150 to 200 μm obtained in step (4).

Preferably, the process further comprises the step of (A) subjecting the coarse fraction obtained in step (2) to a heat-moisture treatment between steps (2) and (3). The heat-moisturized coarse fraction from step (A) is pulverized by impact grinding in step (3).

The average particle size of the fine fraction is usually less than a size ranging from 150 to 200 μm, preferably less than a size ranging from 150 to 180 μm, more preferably less than 150 μm. When the ground product is classified using a sieve, the aperture of the sieve to be used is usually 150 to 200 μm, preferably 150 to 180 μm, more preferably 150 μm. When classification is effected using an air classifier, the air flow rate, the kind and the rotational speed of a classifying rotor, and the like are appropriately selected so that the ground product can be separated into a fine fraction with an average particle size less than a size ranging from 150 to 200 μm and a coarse fraction with an average particle size at or above a size ranging from 150 to 200 μm, provided that the average particle size of the coarse fraction is larger than that of the fine fraction.

The ground wheat is thus fractionated into a fine fraction with an average particle size less than a size ranging from 150 to 200 μm, preferably less than a size ranging from 150 to 180 μm, more preferably less than 150 μm, and a coarse fraction with an average particle size at or above a size ranging from 150 to 200 μm, preferably at or above a size ranging from 150 to 180 μm, more preferably at or above 150 μm, provided that the average particle size of the coarse fraction is more than that of the fine fraction.

The present invention also provides whole wheat flour prepared by the above process and various processed products prepared from the wheat flour.

The process of the invention efficiently produces whole wheat flour with an average particle size less than a maximum size of from 150 to 200 μm, preferably less than a size ranging from 150 to 180 μm, more preferably less than 150 μm, in which wheat bran (outer layer of wheat grains) has been finely ground with little damage to starch and gluten of wheat. The whole wheat flour produced by the process is not only rich in nutrients including fiber, vitamins and minerals but also easily processable and provides processed products good in flavor and texture. In particular, the whole wheat flour produced by the process including step (A) in which the coarse fraction from step (2) is heat-moisturized between steps (2) and (3) has the outer layer finely pulverized and has various enzymes (e.g., amylase, protease) occurring in the outer layer deactivated or, at least, has reduced enzyme activities and therefore exhibits further improved processability to provide processed products with further improved flavor and texture.

The whole wheat flour produced by the process of the invention is very useful as a material to be processed into various processed foods such as breads, cakes, and noodles. When processed into bread, for example, the whole wheat flour has improved breadmaking workability and provides bread with excellent in crumb structure, outer appearance, texture, and flavor.

### BRIEF DESCRIPTION OF THE DRAWINGS

FIG. 1 is a flow chart schematically showing the process of making whole wheat flour according to WO 2005/058044.

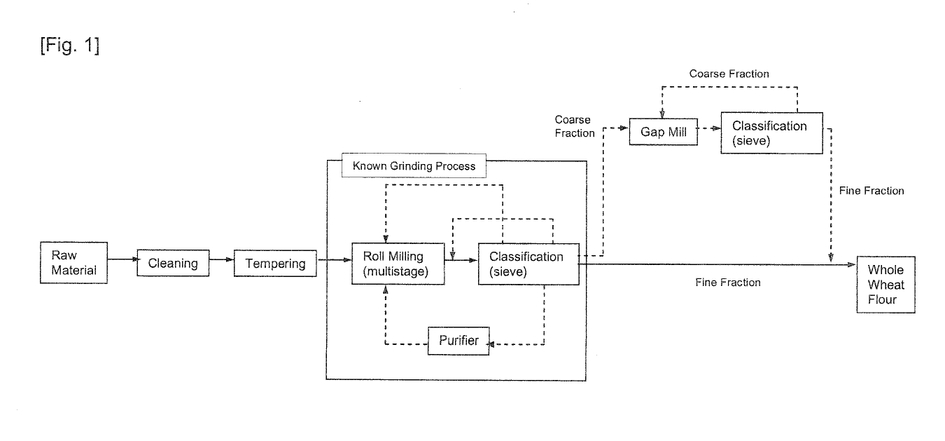

FIG. 2 is a flow chart schematically showing a preferred embodiment of the process of making whole wheat flour according to the present invention.

FIG. 3 is a flow chart schematically showing a preferred embodiment of the process of making whole wheat flour according to the present invention including step (A).

FIG. 4 are sketches of a powder sterilizer disclosed in Japanese Patent 2784505, in which FIG. 4A is a side view, and FIG. 4B is an end-face view.

### DESCRIPTION OF THE PREFERRED EMBODIMENT

The process of producing whole wheat flour according to the invention will be described with reference to its preferred embodiments.

In step (1), raw wheat kernels cleaned in a usual manner are coarsely ground either after tempering (adding water and conditioning the water content of the kernels) or without tempering. Preferably, the clean wheat is ground without tempering. The coarse grinding may be carried out by roll milling or impact milling, preferably by a combination of roll milling and impact milling. When roll milling and impact milling are combined, roll milling preferably precedes impact milling. While roll milling in ordinary flour milling is repeated several times using a multistage roll mill, the wheat is preferably milled once or twice, more preferably once, in the present invention. The impact mill to be used to carry out impact milling is not particularly limited as long as wheat is ground by mechanical impact between an impact plate and a rotor. For example, a turbo mill or a blade mill is useful. A turbo mill is preferred.

While depending on whether or not tempering is conducted, the degree of coarse grinding is preferably such that the resulting ground product may be classified in the subsequent step to provide a fine fraction with an average particle size less than a size of from 150 to 200 μm in a proportion of about 50% to 80%. When the ground product is classified by sieving, for example, the degree of coarse grinding is preferably such that the fine, undersize fraction that passes through a sieve is 60% to 75%, more preferably 65% to 70%.

Combining roll milling and impact milling in step (1) achieves improved grinding efficiency. When clean wheat is ground as such without tempering, the grinding efficiency is further improved.

In step (2), the coarse product obtained in step (1) is classified with a sieve or an air classifier into a fine fraction with an average particle size less than a size ranging from 150 to 200 μm and a coarse fraction the average particle size of which is greater than that of the fine fraction and is equal to or greater than a size ranging from 150 to 200 μm, preferably a fine fraction with an average particle size less than a size ranging from 150 to 180 μm and a coarse fraction with an average particle size at or above a size ranging from 150 to 180 μm, more preferably a fine fraction with an average particle size less than 150 μm and a coarse fraction with an average particle size of 150 μm or more.

When the ground product is classified using a sieve, the aperture of the sieve to be used is 150 to 200 μm, preferably 150 to 180 μm, more preferably 150 μm. In the case of sieving, the ground product is separated into a fine undersize fraction passing the sieve and having a particle size less than a size of from 150 to 200 μm, preferably less than a size of from 150 to 180 μm, more preferably less than 150 μm, and a coarse oversize fraction remaining on the sieve and having a particle size from at or above a size of from 150 to 200 μm, preferably at or above a size of from 150 to 180 μm, more preferably 150 μm or more.

When an air classifier is used, it is preferred to use a classifier capable of separating the ground product into a fine fraction and a coarse fraction below and above a size threshold selected from the range from 150 to 200 μm with good precision. Such an air classifier is exemplified by Turbo Classifier (trade name) available from Nisshin Engineering Inc.

In step (3), the coarse fraction with an average particle size at or above a size ranging from 150 to 200 μm obtained in step (2) is pulverized by impact grinding. The degree of pulverizing is preferably such that classification in the subsequent step provides a fine fraction with an average particle size less than a size ranging from 150 to 200 μm in a proportion of about 80% to 100%, more preferably 90% to 100%. When the ground product is classified by sieving, the degree of pulverization is preferably such that the fine undersize fraction that passes through a sieve is 80% to 100%, more preferably 90% to 100%.

When in using an air classifier in the subsequent step, pulverization of the coarse fraction and the air classification of the pulverized product may be performed separately, or the pulverization and air classification may be carried out almost simultaneously by use of an impact pulverizer having a built-in air classifier. It is preferred to perform pulverization and classification using such an impact pulverizer with a built-in air classifier in view of equipment and cost saving.

In step (4), the ground product from step (3) is classified using a sieve or an air classifier in the same manner as in step (2). Specifically, the ground product is separated into a fine fraction with an average particle size less than a size ranging from 150 to 200 μm and a coarse fraction with the average particle size of which is greater than that of the fine fraction and at or above a size ranging from 150 to 200 μm, preferably a fine fraction with an average particle size less than a size ranging from 150 to 180 μm and a coarse fraction with an average particle size at or above a size ranging from 150 to 180 μm, more preferably a fine fraction with an average particle size less than 150 μm and a coarse fraction with an average particle size of 150 μm or more.

When the ground product is classified using a sieve, the aperture of the sieve to be used is 150 to 200 μm, preferably 150 to 180 μm, more preferably 150 μm. In the case of sieving, the ground product is separated into a fine undersize fraction passing the sieve and having a particle size less than a size ranging from 150 to 200 μm, preferably less than a size ranging from 150 to 180 μm, more preferably less than 150 μm, and a coarse oversize fraction remaining on the sieve and having a particle size at or above a size ranging from 150 to 200 μm, preferably at or above a size ranging from 150 to 180 μm, more preferably at or above 150 μm.

When an air classifier is used, it is preferred to use a classifier capable of separating the ground product into a fine fraction and a coarse fraction below and above a size threshold selected from the range from 150 to 200 μm with good precision. As stated above with regard to step (3), it is recommended to carry out the pulverization and classification using an impact pulverizer with a built-in air classifier. Even when classification of step (4) is conducted with a sieve, it is preferred to use an impact pulverizer with a built-in air classifier to increase the fine fraction passing the sieve. A pulverizer of that type is exemplified by ACM Pulverizer (trade name) available from Hosokawa Micron Limited.

Whether the classification of step (4) is conducted with a sieve or an air classifier, it is preferred that the coarse fraction, if produced in step (4), be returned to step (3). The operation of returning the coarse fraction to step (3) may be repeated, if necessary. Returning the coarse fraction to step (3) makes it feasible to pulverize the hard bran fraction. However, excessive repetition of this operation causes structural damage to starch and gluten present in the ground product.

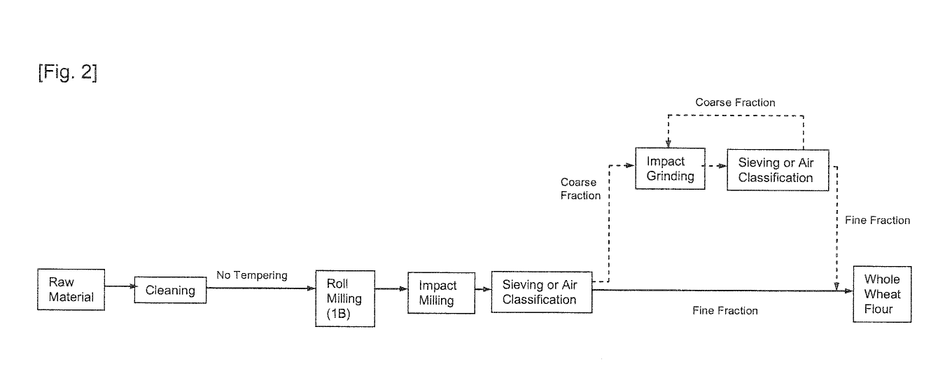

In step (5), the fine fraction from step (2) and the fine fraction from step (4) are combined to give whole wheat flour excellent in processability as well as flavor and texture. A schematic flow charge of steps (1) through (5) described above is shown in FIG. 2.

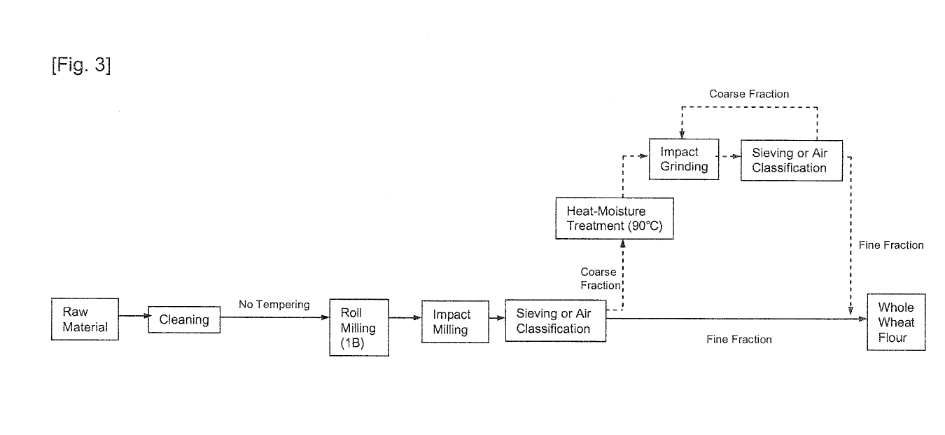

The process of the invention preferably further includes step (A) between steps (2) and (3), wherein the coarse fraction from step (2) is subjected to a heat-moisture treatment. In this case, the heat-moisturized coarse fraction from step (A) is pulverized by impact grinding in step (3). A flow chart of the preferred process including step (A) is shown in FIG. 3.

The heat-moisture treatment of step (A) is carried out under such conditions as to deactivate various enzymes such as amylase and protease without damaging starch present in the coarse fraction. The heat-moisture treatment is usually effected in a closed container into which steam is introduced at a product temperature of 85° to 98° C., preferably 90° to 95° C., for a retention time of 1 to 60 seconds, preferably 5 to 30 seconds. Preferably, the heat-moisture treatment is performed by use of the powder sterilizer disclosed in Japanese Patent 2784505. In this case, the coarse fraction from step (2) is introduced into the powder sterilizer, and, simultaneously therewith, saturated steam is introduced into the sterilizer, and the fraction is treated at the above recited temperature for the above recited retention time. The thus heat-moisturized coarse fraction becomes easier to pulverize in the following step.

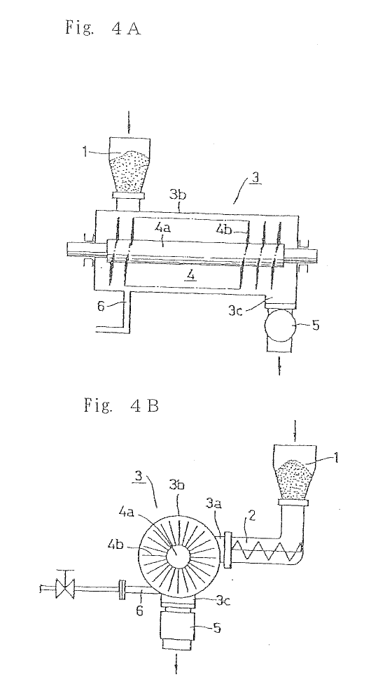

The powder sterilizer according to Japanese Patent 2784505 comprises a pressure barrel 3b and a stirrer 4. The pressure barrel 3b has a powder inlet 3a near one end thereof, a powder outlet 3c near the other end thereof, and a saturated steam inlet 6. The stirrer 4 is inside the barrel 3b and rotates to transfer powder fed through the inlet 3a to the outlet 3c while stirring the powder. The stirrer 4 has a rotational shaft 4a around which a number of stirring pins 4b almost reaching the inner wall of the barrel are implanted in a helical pattern such that, when viewed from a direction perpendicular to the axial direction of the shaft 4a, the traces of the rotating pins 4b are aligned in the axial direction of the shaft 4a leaving no substantial space therebetween. In FIG. 4, numeral 1 indicates a hopper containing powder; 2, a material seal screw; 3, a horizontal high speed mixer having the stirrer 4; and 5, a rotary valve.

The whole wheat flour produced by the process of the invention contains a hard-to-grind bran fraction in a sufficiently finely ground form. It has an average particle size less than a size ranging usually of from 150 to 200 μm. The average particle size of the whole wheat flour is preferably less than 100 μm, more preferably from 40 to 80 μm, even more preferably 50 to 70 μm. The content of a coarse fraction with a particle size at or above a size ranging from 150 to 200 μm, particularly a coarse fraction with a particle size at or above a size ranging from 150 to 180 μm, more particularly a coarse fraction with a particle size at or above 150 μm, is less than 5%, preferably less than 3%, e.g., in the range of from 0.3% to 3%, by mass.

The whole wheat flour produced by the process of the invention is suitable for making breads, noodles, cakes, and the like by selecting the raw material wheat as appropriate to the intended purpose. The content of the whole wheat flour of the invention in total cereal flour ranges usually from 10% to 100% by mass, preferably from 50% to 100% by mass, while varying according to the use. In making noodles, a preferred content of the whole wheat flour of the invention in total cereal flour is from 10% to 50% by mass.

The present invention will be illustrated in greater detail with reference to Examples, but it should be understood that the invention is not construed as being limited thereto. Unless otherwise noted, all the percents and parts are by mass.

### Example 1

Hard wheat kernels were cleaned and, without tempering, ground first in a roll mill (roll mill 1B) and then in a turbo mill (from Tokyo Seifunki Co., Ltd.) as an impact mill. The ground product was classified using a 150 μm aperture sieve into a fine undersize fraction (smaller than 150 μm) and a coarse oversize fraction (150 μm or greater). The average particle size of the fine fraction was 53 μm, and that of the coarse fraction was 321 μm.

The coarse fraction was pulverized using an impact pulverizer (ACM Pulverizer from Hosokawa Micron, Ltd.) and sieved using a 150 μm aperture sieve to collect a fine undersize fraction with a particle size less than 150 μm (a fine bran fraction).

The fine bran fraction was mixed with the previously separated fine fraction with an average particle size of 53 μm to obtain whole wheat flour for bread. The resulting whole wheat flour had an average particle size of about 50 μm and contained 0.3% of a coarse fraction with a particle size of 150 μm or greater.

### Example 2

Hard wheat kernels were cleaned and, without tempering, ground first in a roll mill (roll mill 1B) and then in a turbo mill (from Tokyo Seifunki Co., Ltd.) as an impact mill. The ground product was classified using a 150 μm aperture sieve into a fine undersize fraction (smaller than 150 μm) and a coarse oversize fraction (150 μm or greater). The average particle size of the fine fraction was 53 μm, and that of the coarse fraction was 321 μm.

The coarse fraction was pulverized using an impact pulverizer (ACM Pulverizer from Hosokawa Micron, Ltd.) and classified using a 150 μm aperture sieve into a fine undersize fraction with a particle size less than 150 μm (a fine bran fraction) and a coarse oversize fraction with a particle size of 150 μm or greater. The undersize fraction was collected, while the oversize fraction was returned to the ACM Pulverizer and pulverized again, followed by classification in the same manner to collect a fine undersize fraction with a particle size less than 150 μm. The thus collected fine fractions with a particle size less than 150 μm were combined with the previously collected fine fraction with an average particle size of 53 μm to give whole wheat flour for bread. The resulting whole wheat flour had an average particle size of about 50 μm and contained 0.2% of a coarse fraction with a particle size of 150 μm or greater.

### Example 3

Whole wheat flour for noodle was prepared in the same manner as in Example 2, except for using medium wheat for noodle in place of hard wheat.

### Example 4

Whole wheat flour for cake was prepared in the same manner as in Example 2, except for using soft wheat in place of hard wheat.

### Example 5

Hard wheat kernels were cleaned and, without tempering, ground first in a roll mill (roll mill 1B) and then in a turbo mill (from Tokyo Seifunki Co., Ltd.) as an impact mill. The ground product was classified using an air classifier (Turbo Classifier, from Nisshin Engineering Inc.) into a fine fraction with an average particle size less than 150 μm and a coarse fraction with an average particle size of 150 μm or greater. The average particle size of the fine fraction was 68 μm, and that of the coarse fraction was 445 μm.

The coarse fraction was pulverized using an impact pulverizer equipped with a built-in air classifier (ACM Pulverizer from Hosokawa Micron, Ltd.) to collect a fine fraction with an average particle size less than 150 μm, which was mixed with the previously collected fine fraction with an average particle size of 68 μm to give whole wheat flour for bread. The whole wheat flour had an average particle size of about 60 μm and contained 1.4% of a coarse fraction with a particle size of 150 μm or greater.

### Test Example 1 and Comparative Test Examples 1 and 2

French bread was made as follows using the whole wheat flour of Example 2 (Test Example 1), commercially available whole wheat flour 1 (Graham Bread Flour from Nisshin Flour Milling Co., Ltd.) (Comparative Test Example 1) or commercially available whole wheat flour 2 (Ultragrain™ from ConAgra Foods Inc.; whole wheat flour prepared by the process of WO 2005/058044) (Comparative Test Example 2).

A hundred parts of the whole wheat flour, 1 part of instant dry yeast, 0.2 parts of a dough conditioner for French bread, 0.1 parts of an emulsifying agent, 2 parts of salt, and an adequate amount (see Table 1 below) of water were mixed at a low speed for 5 minutes, at a medium speed for 3 minutes, and then at a high speed for 2 minutes to prepare a bread dough (mixing temperature: 28.0° C.). After fermentation at room temperature for 20 minutes, the dough was divided into portions each weighing 250 g. After a bench time of 20 minutes, the dough was shaped, given a final proof (secondary fermentation) at 32° C. and 80% RH for 65 minutes, and baked at 230° C. for 25 minutes to make French bread.

The French bread was organoleptically evaluated by a panel of 10 members in accordance with the scoring system shown in Table 2 below. The results (averages of the scores by the panel) are shown in Table 1. The volume of the bread is also shown in Table 1.

TABLE 1

| | | | Comparative | Comparative |
|---|---|---|---|---|
| | | Test | Test | Test |
| | | Example 1 | Example 1 | Example 2 |
| Whole Wheat Flour of | | 100% | | |
| Example 2 | | | | |
| Compara. Whole Wheat | | | 100% | |
| Flour 1 | | | | |
| Compara. Whole Wheat | | | | 100% |
| Flour 2 | | | | |
| Water Absorption (%) | | 72 | 71 | 73 |
| Results of | Workability in | 4.0 | 3.0 | 2.2 |
| Evaluation | Shaping | | | |
| | Crumb Structure | 4.0 | 3.0 | 1.6 |
| | Texture | 4.0 | 3.0 | 2.0 |
| | Flavor | 4.0 | 3.0 | 2.2 |
| | Appearance | 4.2 | 3.0 | 1.5 |

| | | | |
|---|---|---|---|
| Volume (cc) | 700 | 660 | 530 |

TABLE 2

| Score | Workability | Crumb | Texture | Flavor | Appearance |
|---|---|---|---|---|---|
| 5 | very | very good | soft and very | good flavor, | slashes opened up |
| | good | crumb structure | good | good taste | into nice cracks, |
| | | with very thin | moisture | | good volume |
| | | cell walls | | | |
| 4 | good | good crumb | slightly soft | slightly good | slashes opened up |
| | | structure with | and good | flavor, slightly | into slightly nice |
| | | thin cell walls | moisture | good taste | cracks, slightly |
| | | | | | good volume |
| 3 | average | average crumb | average in | average in | slashes opened up |
| | | structure with | softness and | flavor and | into average |
| | | slightly thin | moisture | taste | cracks, average |
| | | cell walls | | | volume |
| 2 | slightly | slightly poor | slightly poor | slight branny | poorly opened |
| | poor | crumb structure | soft texture | smell, slight | cracks of slashes, |
| | | with slightly | with slightly | bitter taste | slightly poor |
| | | thick cell walls | poor | | volume |
| | | | moisture | | |
| 1 | poor | poor crumb | no softness, | strong branny | poorly opened |
| | | structure with | poor | smell, strong | cracks of slashes, |
| | | thick cell walls | moisture | bitter taste | poor volume |

### Example 6

Whole wheat flour for bread was prepared in the same manner as in Example 1, except that the coarse fraction was heat-moisturized at a powder temperature of 90° C. for a retention time of about 5 seconds in a powder sterilizer disclosed in JP 2784505 B into which saturated steam was introduced before being subjected to the impact pulverization in ACM Pulverizer. The resulting whole wheat flour had an average particle size of about 50 μm and contained less than 3% of a coarse fraction with a particle size of 150 μm or greater.

### Example 7

Whole wheat flour for bread was prepared in the same manner as in Example 2, except that the coarse fraction was heat-moisturized at a powder temperature of 90° C. for a retention time of about 5 seconds in a powder sterilizer disclosed in JP 2784505 B into which saturated steam was introduced before being subjected to the impact pulverization in ACM Pulverizer. The ratio of heat for gelatinization of the heat-moisturized coarse fraction to that of the untreated coarse fraction was 95. The resulting whole wheat flour had an average particle size of about 50 μm and contained less than 3% of a coarse fraction with a particle size of 150 μm or greater.

### Example 8

Whole wheat flour for noodle was prepared in the same manner as in Example 7, except for using medium wheat for noodles as raw wheat kernels.

### Example 9

Whole wheat flour for cakes was prepared in the same manner as in Example 7, except for using soft wheat as raw wheat kernels.

### Example 10

Whole wheat flour for bread was prepared in the same manner as in Example 5, except that the coarse fraction was heat-moisturized at a powder temperature of 90° C. for a retention time of about 5 seconds in a powder sterilizer disclosed in JP 2784505 B into which saturated steam was introduced before being subjected to the impact pulverization in ACM Pulverizer equipped with a built-in air classifier. The resulting whole wheat flour had an average particle size of about 60 μm and contained 1.4% of a coarse fraction with a particle size of 150 μm or greater.

### Example 11

Hard wheat kernels were cleaned and, without tempering, ground first in a roll mill (roll mill 1B) and then in a turbo mill (from Tokyo Seifunki Co., Ltd.) as an impact mill. The ground product was classified using a 175 μm aperture sieve into a fine undersize fraction with a particle size less than 175 μm and a coarse oversize fraction with a particle size of 175 μm or greater. The average particle size of the fine fraction was 66 μm, and that of the coarse fraction was 470 μm.

The coarse fraction was heat-moisturized at a powder temperature of 90° C. for about 5 seconds by means of a powder sterilizer disclosed in JP 2784505 B in which saturated steam was introduced. The thus heat-moisturized coarse fraction was pulverized using an impact pulverizer equipped with a built-in air classifier (ACM Pulverizer from Hosokawa Micron, Ltd.) to collect a fine fraction with an average particle size less than 175 μm (a fine bran fraction).

The fine bran fraction was combined with the previously separated fine fraction with an average particle size of 66 μm to obtain whole wheat flour for bread. The resulting whole wheat flour had an average particle size of about 50 μm and contained less than 0.3% of a coarse fraction with a particle size of 175 μm or greater.

### Test Example 2

French bread was made and evaluated in the same manner as in Test Example 1, except for using the whole wheat flour of Example 7. The results as well as the volume of the bread are shown in Table 3. To help comparison, the results of Comparative Test Examples 1 and 2 are also shown in Table 3.

TABLE 3

| | | | Comparaive | Comparaive |
|---|---|---|---|---|
| | | Test | Test | Test |
| | | Example 2 | Example 1 | Example 2 |
| Whole Wheat Flour of | | 100% | | |
| Example 7 | | | | |
| Compara. Whole Wheat | | | 100% | |
| Flour 1 | | | | |
| Compara. Whole Wheat | | | | 100% |
| Flour 2 | | | | |
| Water Absorption (%) | | 80 | 71 | 73 |
| Results of | Workability in | 5.0 | 3.0 | 2.2 |
| Evaluation | Shaping | | | |
| | Crumb Structure | 5.0 | 3.0 | 1.6 |
| | Texture | 5.0 | 3.0 | 2.0 |
| | Flavor | 5.0 | 3.0 | 2.2 |
| | Appearance | 5.0 | 3.0 | 1.5 |

| | | | |
|---|---|---|---|
| Volume (cc) | 750 | 660 | 530 |

The results of Test Examples 1 and 2 and Comparative Test Examples 1 and 2 prove that the whole wheat flour prepared by the process of the present invention exhibits improved workability in breadmaking, i.e., improved processability compared with the conventional whole wheat flour products and provides French bread superior in not only crumb structure, volume and outer appearance but flavor and texture to those prepared from the conventional whole wheat flour products. In contrast, the conventional whole wheat flour products, particularly comparative whole wheat flour 2 (the one produced by the process of WO 2005/058044, commercially available under a trade mark Ultragrain from ConAgra) has poor processability and provides low quality French bread. These results support the following: (1) the whole wheat flour used in Comparative Test Example 2 suffers from damage to starch and gluten due to poor grinding efficiency, and (2) the whole wheat flour produced by the process of the invention suffers from no or little damage to starch and gluten owing to the fact that the wheat kernels have been efficiently ground.

### Test Example 3 and Comparative Test Examples 3 and 4

Round top bread (one-loaf bread) was made using the whole wheat flour obtained in Example 11 (Test Example 3), comparative whole wheat flour 1 (Comparative Test Example 3), or comparative whole wheat flour 2 (Comparative Test Example 4) as follows.

A hundred parts of the whole wheat flour, 5 parts of gluten powder, 4 parts of yeast, 3 parts of fat and oil, 0.1 parts of yeast food, 6 parts of sugar, 2 parts of salt, 2 parts of skim milk powder, 5 parts of honey, 0.5 parts of an emulsifying agent, and an adequate amount (see Table 4 below) of water were mixed at a low speed for 3 minutes, at a medium speed for 4 minutes, and then at a high speed for 3 minutes to prepare a bread dough (mixing temperature: 27.0° C.). After fermentation at room temperature for 40 minutes, the dough was divided into portions each weighing 500 g. After a bench time of 20 minutes, the dough was shaped, given a final proof (secondary fermentation) at 38° C. and 85% RH for about 40 minutes, and baked at 190° C. for 30 minutes to make one-loaf bread.

The bread was organoleptically evaluated by a panel of 10 members in accordance with the scoring system shown in Table 5 below. The results (averages of the scores by the panel) are shown in Table 4. The volume of the bread is also shown in Table 4.

TABLE 4

| | | | Compara. | Compara. |
|---|---|---|---|---|
| | | Test | Test | Test |
| | | Example 3 | Example 3 | Example 4 |
| Whole Wheat Flour of | | 100% | | |
| Example 11 | | | | |
| Compara. Whole Wheat Flour 1 | | | 100% | |
| Compara. Whole Wheat Flour 2 | | | | 100% |
| Water Absorption (%) | | 78 | 70 | 75 |
| Results of | Mixing Tolerance | 5.0 | 3.5 | 2.8 |
| Evaluation | Dividing and Shaping | 5.0 | 4.0 | 3.0 |
| | Workability | | | |
| | Crumb Structure | 5.0 | 4.5 | 2.5 |
| | Texture | 5.0 | 3.0 | 1.5 |
| | Taste and Flavor | 5.0 | 2.5 | 1.0 |

| | | | |
|---|---|---|---|
| Volume (cc) | 1970 | 1970 | 1780 |

TABLE 5

| | | Dividing & | | | |
|---|---|---|---|---|---|
| | | Shaping | | | |
| Score | Mixing Tolerance | Workability | Crumb | Texture | Taste and Flavor |
| 5 | good mixing tolerance showing | very good | very good crumb structure with | soft, very good | full of body and |
| | long dough-stability time | | very thin cell walls | melt-in-the-mouth | flavor |
| 4 | slightly good mixing tolerance | good | good crumb structure with thin | slightly soft, good | slightly full of |
| | showing slightly long dough- | | cell walls | melt-in-the-mouth | body and flavor |
| | stability time | | | | |
| 3 | average mixing tolerance | average | average crumb structure with | average in softness | average in body |
| | showing average dough-stability | | slightly thin cell walls | and melt-in-the-mouth | and flavor |
| | time | | | | |
| 2 | slightly poor mixing tolerance | slightly poor | slightly poor crumb structure | slight poor in softness | slightly less body |
| | showing slightly short dough- | | with slightly thick cell walls | and melt-in-the-mouth | and flavor |
| | stability time | | | | |
| 1 | poor mixing tolerance showing | poor | poor crumb structure with thick | no softness, poor | poor body and |
| | short dough-stability time | | cell walls | melt-in-the-mouth | flavor |

The results of Test Example 3 in view of Comparative Test Examples 3 and 4 show that the whole wheat flour produced by the process of the present invention has improved mixing resistance, i.e., processability, in the preparation of bread dough compared with the conventional whole wheat flours and that the whole wheat flour of the invention provides bread superior in not only crumb structure and volume but texture, taste, and flavor. In using the conventional whole wheat flours, particularly comparative whole wheat flour 2 used in Comparative Test Example 4, in contrast, the dough has poor mixing resistance, i.e., poor processability and provides bread with poor qualities. These results support the following: (1) the whole wheat flour used in Comparative Test Example 4 suffers from damage to starch and gluten due to poor grinding efficiency, and (2) the whole wheat flour of the invention suffers from no or little damage to starch and gluten owing to the fact that the wheat kernels have been efficiently ground.

### Test Example 4 and Comparative Test Examples 5 and 6

Bar cookies were made using the whole wheat flour for cakes of Example 9 (Test Example 4), comparative whole wheat flour 2 (Comparative Test Example 5), or comparative whole wheat flour 3 (commercially available whole wheat flour) (Comparative Test Example 6) as follows.

Forty five parts of margarine was stirred with a beater at a high speed for 1 minute. Thirty five parts of soft white sugar and 0.5 parts of salt were added thereto, followed by mixing at a low speed for 30 seconds and then at a high speed for 1 minute. Twelve parts of whole egg was added, followed by further mixing at a low speed for 1 minute and then at a high speed for 1 minute. A hundred parts of the whole wheat flour, 1 part of baking powder, and an adequate amount (shown in Table 6) of water were further added, followed by mixing at a low speed for 2 minutes to prepare a cookie dough (mixing temperature: 26.0° C.). After resting in a refrigerator for 15 hours, the dough was rolled into a 15 mm thick sheet and cut into 2 cm by 4 cm pieces. The pieces of the dough were pricked at the center with a fork and baked at 180° C. for 20 minutes to make bar cookies.

The workability of the dough and the bar cookies were evaluated by a panel of 10 members in accordance with the scoring system shown in Table 7 below. The results (averages of the scores by the panel) are shown in Table 6 below.

TABLE 6

| | | Test | Compara. Test | Compara. Test |
|---|---|---|---|---|
| | | Example 4 | Example 5 | Example 6 |
| Whole Wheat Flour of | | 100% | | |
| Example 9 | | | | |
| Comparative Whole Wheat | | | 100% | |
| Flour 2 | | | | |
| Comparative Whole Wheat | | | | 100% |
| Flour 3 | | | | |
| Water Absorption (%) | | 10 | 10 | 10 |
| Results of | Workability in | 4.5 | 2.0 | 1.0 |
| Evaluation | Shaping | | | |
| | Texture | 4.2 | 1.4 | 1.0 |
| | Flavor | 4.0 | 1.8 | 1.0 |
| | Appearance | 4.1 | 3.0 | 1.0 |

TABLE 7

| | Workability | | | |
|---|---|---|---|---|
| Score | in Shaping | Texture | Flavor | Appearance |
| 5 | very good | crispy, very good | good flavor, good | very uniform in |
| | | melt-in-the-mouth | taste | shape |
| 4 | good | slightly crispy, slightly | slightly good flavor, | slightly uniform |
| | | good melt-in-the-mouth | slightly good taste | in shape |
| 3 | average | average in crispiness | average in flavor and | average in |
| | | and melt-in-the-mouth | taste | uniformity of |
| | | | | shape |
| 2 | slightly poor | slightly crumbly, | slight branny smell, | slightly |
| | | slightly sticky, slightly | slight bitter taste | non-uniform in |
| | | poor melt-in-the-mouth | | shape |
| 1 | poor | crumbly, sticky, poor | strong branny smell, | very |
| | | melt-in-the-mouth | strong bitter taste | non-uniform in |
| | | | | shape |

### Test Example 5 and Comparative Text Example 7

Udon noodles (Japanese noodle) were made using the whole wheat flour for noodles of Example 8 (Test Example 5) or comparative whole wheat flour 3 (Comparative Test Example 7) as follows.

Thirty percent of the whole wheat flour and 70% of commercially available wheat flour for noodles (Kinsuzuran, from Nisshin Flour Milling Co., Ltd.) were mixed. A hundred parts of the mixed flour was mixed with 35 parts of water containing 3 parts of salt dissolved therein for 12 minutes to prepare a dough. The dough was sheeted through a pair of rolls set at a clearance of 3.6 mm, followed by resting in a plastic bag for 30 minutes at room temperature (about 20° C.). After the resting, the dough sheet was again passed between rolls into a dough sheet having a final thickness of about 2.5 mm, which was cut into strands by passage between No. 10 square-grooved cutting rolls to make Udon noodles.

The udon noodles were cooked in boiling water for 18 minutes, rinsed with cold water, and strained. The workability and the cooked udon noodles were scored by a panel of 10 members in accordance with the scoring system shown in Table 9 below. The results (averages of the scores by the panel) are shown in Table 8 below.

TABLE 8

| | | | Comparative |
|---|---|---|---|
| | | Test Example 5 | Test Example 7 |
| Whole Wheat Flour of Example 8 | | 30% | |
| Comparative Whole Wheat Flour 3 | | | 30% |
| Commercially Available | | 70% | 70% |
| Wheat Flour for Noodles | | | |
| Workability in Noodle Making | | 4.1 | 2.2 |
| Texture | Viscoelasticity | 4.1 | 1.7 |
| | Smoothness | 3.8 | 1.6 |

| | | |
|---|---|---|
| Taste & Flavor | 4.1 | 1.8 |

TABLE 9

| | Workability | | | |
|---|---|---|---|---|
| | in Noodle | Texture | | |
| Score | Making | Viscoelasticity | Smoothness | Taste & Flavor |
| 5 | very good | very good | very good | good flavor, good taste |
| 4 | good | good | good | slightly good flavor, slightly |
| | | | | good taste |
| 3 | average | average | average | average in flavor and taste |
| 2 | slightly | slightly poor | slightly poor with | slight branny smell, slight |
| | poor | | slight roughness | bitter taste |
| 1 | poor | poor | poor with | strong branny smell, strong |
| | | | roughness | bitter taste |

### Test Example 6 and Comparative Test Example 8

Chinese noodles were made using the whole wheat flour for noodles of Example 8 (Test Example 6) or comparative whole wheat flour 3 (Comparative Test Example 8) as follows.

Thirty percent of the whole wheat flour and 70% of commercially available wheat flour for Chinese noodles (Toku Number One, from Nisshin Flour Milling Co., Ltd.) were mixed. A hundred parts of the mixed flour was mixed with 35 parts of water containing 1 part of kansui (alkali salt blend, from Oriental Yeast Co., Ltd.) dissolved therein in a horizontal vacuum mixer under reduced pressure (−600 mmHg) for 10 minutes to prepare a dough. The dough was sheeted by passage between a pair of rolls set at a clearance of 3.2 mm, folded in half, and passed between rolls with the same clearance. This sheeting cycle was repeated twice (three times in total). The resulting dough sheet was allowed to rest in a plastic bag at room temperature (ca. 20° C.) for 30 minutes. After the resting, the dough sheet was further passed between rolls into a final thickness of about 1.4 mm and passed through No. 20 square-grooved cutting rolls to slit into strands.

The noodles were cooked in boiling water for 2 minutes, drained, and put into a bowl filled with hot soup. The workability and the cooked noodles were scored by a panel of 10 members in accordance with the same scoring system shown in Table 9. The results (averages of the scores by the panel) are shown in Table 10.

TABLE 10

| | | | Comparative |
|---|---|---|---|
| | | Test Example 6 | Test Example 8 |
| Whole Wheat Flour of Example 8 | | 30% | |
| Comparative Whole Wheat Flour 3 | | | 30% |
| Commercially Available | | 70% | 70% |
| Wheat Flour for Chinese Noodles | | | |
| Workability in Noodle Making | | 4.5 | 2.0 |
| Texture | Viscoelasticity | 4.2 | 1.4 |
| | Smoothness | 4.0 | 1.8 |

| | | |
|---|---|---|
| Taste & Flavor | 4.1 | 2.6 |

1. A process of producing whole wheat flour comprising the steps of:
(1) coarsely grinding wheat kernels,
(2) separating the resulting ground product into a fine fraction with an average particle size less than a size ranging from 150 to 200 μm and a coarse fraction with an average particle size more than that of the fine fraction and at or above a size ranging from 150 to 200 μm,
(3) pulverizing the coarse fraction by impact grinding,
(4) fractionating the ground product from step (3) to collect a fine fraction with an average particle size less than a size ranging from 150 to 200 μm, and
(5) combining the fine fraction with an average particle size less than a size ranging from 150 to 200 μm obtained in step (2) and the fine fraction with an average particle size less than a size ranging from 150 to 200 μm obtained in step (4).

2. The process according to claim 1, further comprising the step of (A) subjecting the coarse fraction obtained in step (2) to a heat-moisture treatment between steps (2) and (3), wherein the heat-moisturized fraction from step (A) is pulverized by impact grinding in step (3).

3. The process according to claim 2, wherein the heat-moisture treatment is carried out in a closed container into which saturated steam is introduced at a product temperature of 85° to 98 ° C. for a retention time of 1 to 60 seconds.

4. The process according to claim 1, wherein the coarse grinding of step (1) is carried out by a combination of roll milling and impact milling.

5. The process according to claim 1, wherein the separation of step (2) is carried out by classifying the ground product from step (1) using a sieve having an aperture of 150 to 200 μm into an undersize fraction and an oversize fraction.

6. The process according to claim 1, wherein the separation of step (2) is carried out by classifying the ground product from step (1) using an air classifier into a fine fraction with an average particle size less than a size ranging from 150 to 200 μm and a coarse fraction with an average particle size at or above a size ranging from 150 to 200 μm.

7. The process according to claim 1, wherein the fractionation of step (4) is carried out by classifying the ground product from step (3) using a sieve having an aperture of 150 to 200 μm to collect an undersize fraction.

8. The process according to claim 1, wherein the fractionation of step (4) is carried out by classifying the ground product from step (3) using an air classifier to collect a fine fraction with an average particle size less than a size ranging from 150 to 200 μm.

9. The process according to claim 1, wherein the residual coarse fraction with an average particle size at or above a size ranging from 150 to 200 μm obtained in step (4) is returned to step (3).

10. Whole wheat flour produced by the process according to claim 1.
